(19) United States
(12) Patent Application Publication
(10) Pub. No.: US 2013/0288737 A1
(43) Pub. Date: Oct. 31, 2013

(54) APPARATUS AND METHOD TO MANAGE INTERFERENCE BETWEEN COMMUNICATION NODES

(71) Applicants: Markus Nentwig, Helsinki (FI); Pekka Janis, Espoo (FI)

(72) Inventors: Markus Nentwig, Helsinki (FI); Pekka Janis, Espoo (FI)

(73) Assignee: NOKIA CORPORATION, Espoo (FI)

(21) Appl. No.: 13/822,787

(22) PCT Filed: Sep. 21, 2010
(86) PCT No.: PCT/IB10/54273

§ 371 Date: Jul. 2, 2013

(51) Int. Cl. H04W 52/24

(52) U.S. Cl. CPC H04W 52/243
USPC 455/522

(57) ABSTRACT

An apparatus, method and system to control a transmitter power level to manage interference between communication nodes in a communication system. In one embodiment, an apparatus includes a processor and memory including computer program code. The memory and the computer program code are configured to, with the processor, cause the apparatus to receive an interference message including a reported interference characteristic associated with a communication resource employed by an interfered communication node and a reported weighting factor indicating an importance of the communication resource to the interfered communication node. The memory and the computer program code are also configured to, with the processor, cause the apparatus to generate a message for a receiving communication node employing the communication resource, and select a transmitter power level for the message as a function of the reported interference characteristic and the reported weighting factor.

### TECHNICAL FIELD

The present invention is directed, in general, to communication systems and, in particular, to an apparatus, method and system to control a transmitter power level to manage interference between communication nodes in a communication system.

### BACKGROUND

Long term evolution (“LTE”) of the Third Generation Partnership Project (“3GPP”), also referred to as 3GPP LTE, refers to research and development involving the 3GPP LTE Release 8 and beyond, which is the name generally used to describe an ongoing effort across the industry aimed at identifying technologies and capabilities that can improve systems such as the universal mobile telecommunication system (“UMTS”). The notation “LTE-A” is generally used in the industry to refer to further advancements in LTE. The goals of this broadly based project include improving communication efficiency, lowering costs, improving services, making use of new spectrum opportunities, and achieving better integration with other open standards.

The evolved universal terrestrial radio access network (“E-UTRAN”) in 3GPP includes base stations providing user plane (including packet data convergence protocol/radio link control/media access control/physical (“PDCP/RLC/MAC/PHY”) sublayers) and control plane (including a radio resource control (“RRC”) sublayer) protocol terminations towards wireless communication devices such as cellular telephones. A wireless communication device or terminal is generally known as user equipment (also referred to as “UE”). A base station is an entity of a communication network often referred to as a Node B or an NB. Particularly in the E-UTRAN, an “evolved” base station is referred to as an eNodeB or an eNB. For details about the overall architecture of the E-UTRAN, see 3GPP Technical Specification (“TS”) 36.300 v8.7.0 (2008-12), which is incorporated herein by reference. For details of the communication or radio resource control management, see 3GPP TS 25.331 v.9.1.0 (2009-12) and 3GPP TS 36.331 v.9.1.0 (2009-12), which are incorporated herein by reference.

As wireless radio communication systems such as cellular telephone, satellite, and microwave communication systems become widely deployed and continue to attract a growing number of users, there is a pressing need to accommodate a large and variable number of communication devices that transmit an increasing quantity of data within a fixed spectral allocation and limited transmitter power levels. The increased quantity of data is a consequence of wireless communication devices transmitting video information and surfing the Internet, as well as performing ordinary voice communications. Such processes are performed while accommodating substantially simultaneous operation of a large number of wireless communication devices.

Cellular communication systems have typically been structured with an architecture that enables wireless communication devices such as user equipment to communicate with another user equipment through one or more intermediary base stations that establish and control communication links or paths between the user equipment. However, direct device-to-device (“D2D”), mobile-to-mobile (“M2M”), terminal-to-terminal (“T2T”), peer-to-peer (“P2P”) communications is also beginning to be broadly integrated into cellular communication systems such as LTE/LTE-A cellular communication systems as specified in the 3GPP. Integration of direct device-to-device communications enable wireless communication devices such as user equipment, mobile devices, terminals, peers, or machines to communicate over a direct wireless communication link that uses communication or radio resources of the cellular communication system or network. In this manner, the communication resources are shared by the devices communicating directly with each other with devices having a communication link to a base station.

Cellular and other wireless communication devices (“communication nodes”) thus generally share common communication resources including common frequency channels and time slots. As a result, increasing a transmitter power level at one communication node to improve that node's throughput and communication quality may cause interference with another communication node such as a neighboring communication node. One of the more problematic issues is how to control a transmitter power level for a communication node operating under an LTE cellular communication system without unfairly producing interference with another communication node. Interference-aware scheduling (“IAS”) is a conventional process in communication systems that makes a tradeoff between interference and throughput (“TP”) by choosing a transmitter power level of a communication node configured to transmit data based on a gain in throughput at the transmitting communication node against a loss of throughput at other communication nodes (such as interfered communication nodes). Interference-aware scheduling may use a utility function to relate the gain of throughput at one communication node to the loss of throughput at another communication node.

A conventional utility function does not take into account that the same throughput is much more valuable to a “resource-poor” communication node compared to a “resource-rich” communication node, thereby disregarding “fairness” in allocation of sparse communication resources. Thus, there is need for interference-aware scheduling that takes environmental circumstances of each communication node into account that avoids the deficiencies of current communication systems.

### SUMMARY OF THE INVENTION

These and other problems are generally solved or circumvented, and technical advantages are generally achieved, by embodiments of the present invention, which include an apparatus, method and system to control a transmitter power level to manage interference between communication nodes in a communication system. In one embodiment, an apparatus includes a processor and memory including computer program code. The memory and the computer program code are configured to, with the processor, cause the apparatus to receive an interference message including a reported interference characteristic associated with a communication resource employed by an interfered communication node and a reported weighting factor indicating an importance of the communication resource to the interfered communication node. The memory and the computer program code are also configured to, with the processor, cause the apparatus to generate a message for a receiving communication node employing the communication resource, and select a transmitter power level for the message as a function of the reported interference characteristic and the reported weighting factor.

In another embodiment, an apparatus includes a processor and memory including computer program code. The memory and the computer program code are configured to, with the processor, cause the apparatus to determine an interference characteristic associated with a communication resource employed by the apparatus, and determine a weighting factor indicating an importance of the communication resource to the apparatus. The memory and the computer program code are also configured to, with the processor, cause the apparatus to format the interference characteristic and the weighting factor into an interference message for transmission to a communication node.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an environment for application of the principles of the present invention;

FIGS. 3 and 4 illustrate system level diagrams of embodiments of communication systems including wireless communication systems that provide an environment for application of the principles of the present invention;

FIG. 5 illustrates a system level diagram of an embodiment of a communication element of a communication system for application of the principles of the present invention;

FIG. 6 illustrates a system level diagram of an embodiment of a communication system including communication nodes that provides an environment for the application of the principles of the present invention;

FIG. 7 illustrates a flowchart of an embodiment of a method of selecting a transmitter power level by a communication node according to the principles of the present invention;

FIG. 8 illustrates a flowchart of an embodiment of a method of determining a weighting factor by a communication node in accordance with the principles of the present invention;

FIG. 9 illustrates a flowchart of an embodiment of generating an interference message by a communication node in accordance with the principles of the present invention; and

FIG. 10 illustrates a flowchart of an embodiment of a method of selecting a transmitter power level for a message by a communication node that may interfere with another communication node in accordance with the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of an apparatus, method and system to control a transmitter power level to manage interference with between communication nodes in a communication system. The apparatus, method and system are applicable, without limitation, to any communication system including existing and future 3GPP technologies such as UMTS, LTE, and its future variants such as 4th generation (“4G”) communication systems.

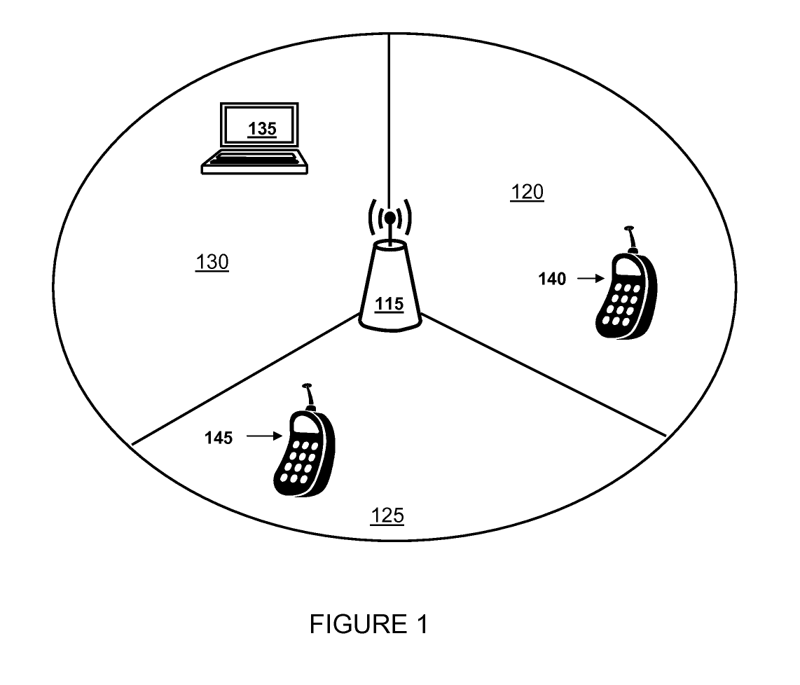

Turning now to FIG. 1, illustrated is a system level diagram of an embodiment of a communication system including a base station 115 and wireless communication devices (e.g., user equipment) 135, 140, 145 that provides an environment for application of the principles of the present invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. The three sectors or more than three sectors are configured per frequency, and one base station 115 can support more than one frequency. Although FIG. 1 illustrates one wireless communication device (e.g., wireless communication device 140) in each sector (e.g. the first sector 120), a sector (e.g. the first sector 120) may generally contain a plurality of wireless communication devices. In an alternative embodiment, a base station 115 may be formed with only one sector (e.g. the first sector 120), and multiple base stations may be constructed to transmit according to co-operative multi-input/multi-output (“C-MIMO”) operation, etc.

The sectors (e.g. the first sector 120) are formed by focusing and phasing radiated signals from the base station antennas, and separate antennas may be employed per sector (e.g. the first sector 120). The plurality of sectors 120, 125, 130 increases the number of subscriber stations (e.g., the wireless communication devices 135, 140, 145) that can simultaneously communicate with the base station 115 without the need to increase the utilized bandwidth by reduction of interference that results from focusing and phasing base station antennas. While the wireless communication devices 135, 140, 145 are part of a primary communication system, the wireless communication devices 135, 140, 145 and other devices such as machines (not shown) may be a part of a secondary communication system to participate in, without limitation, D2D and machine-to-machine communications or other communications. Additionally, the wireless communication devices 135, 140, 145 may form communication nodes along with other devices in the communication system.

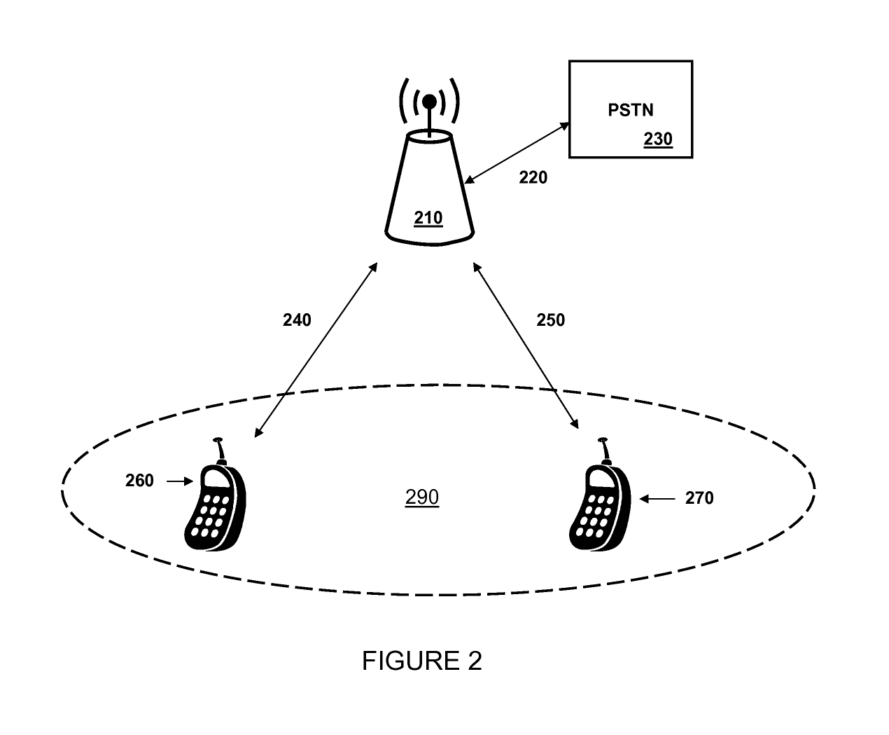

Turning now to FIG. 2, illustrated is a system level diagram of an embodiment of a communication system including a base station 210 and wireless communication devices (e.g., user equipment) 260, 270 that provides an environment for application of the principles of the present invention. The communication system includes the base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to the wireless communication devices 260, 270, respectively, that lie within its cellular area 290.

In operation of the communication system illustrated in FIG. 2, the base station 210 communicates with each wireless communication device 260, 270 through control and data communication resources allocated by the base station 210 over the communication paths 240, 250, respectively. The control and data communication resources may include frequency and time-slot communication resources in frequency division duplex (“FDD”) and/or time division duplex (“TDD”) communication modes. While the wireless communication devices 260, 270 are part of a primary communication system, the wireless communication devices 260, 270 and other devices such as machines (not shown) may be a part of a secondary communication system to participate in, without limitation, device-to-device and machine-to-machine communications or other communications. Additionally, the wireless communication devices 260, 270 may form communication nodes along with other devices in the communication system.

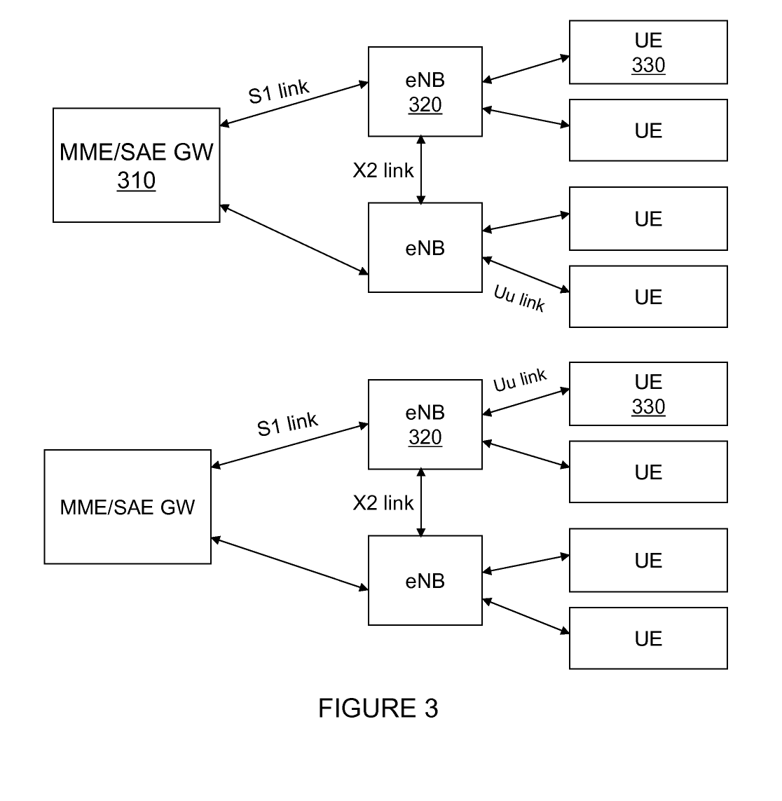

Turning now to FIG. 3, illustrated is a system level diagram of an embodiment of a communication system including a wireless communication system that provides an environment for the application of the principles of the present invention. The wireless communication system may be configured to provide evolved UMTS terrestrial radio access network (“E-UTRAN”) universal mobile telecommunications services. A mobile management entity/system architecture evolution gateway (“MME/SAE GW,” one of which is designated 310) provides control functionality for an E-UTRAN node B (designated “eNB,” an “evolved node B,” also referred to as a “base station,” one of which is designated 320) via an S1 communication link (ones of which are designated “S1 link”). The base stations 320 communicate via X2 communication links (ones of which are designated “X2 link”) The various communication links are typically fiber, microwave, or other high-frequency communication paths such as coaxial links, or combinations thereof.

The base stations 320 communicate with wireless communication devices such as user equipment (“UE,” ones of which are designated 330), which is typically a mobile transceiver carried by a user. Thus, the communication links (designated “Uu” communication links, ones of which are designated “Uu link”) coupling the base stations 320 to the user equipment 330 are air links employing a wireless communication signal such as, for example, an orthogonal frequency division multiplex (“OFDM”) signal. While the user equipment 330 are part of a primary communication system, the user equipment 330 and other devices such as machines (not shown) may be a part of a secondary communication system to participate in, without limitation, D2D and machine-to-machine communications or other communications. Additionally, the user equipment 330 may form a communication node along with other devices in the communication system.

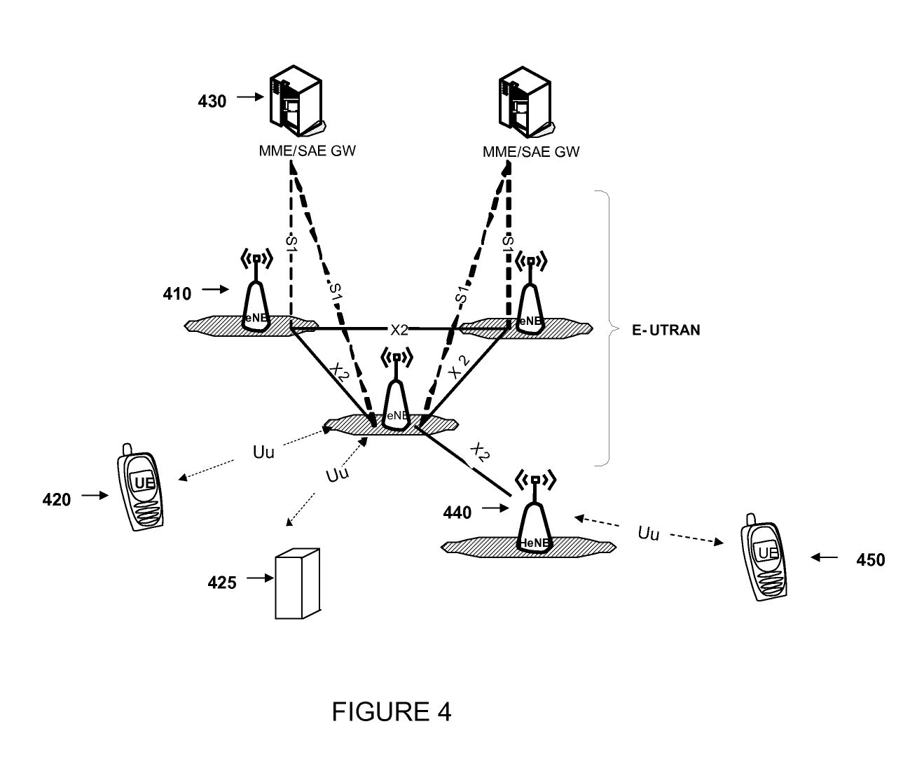

Turning now to FIG. 4, illustrated is a system level diagram of an embodiment of a communication system including a wireless communication system that provides an environment for the application of the principles of the present invention. The wireless communication system provides an E-UTRAN architecture including base stations (one of which is designated 410) providing E-UTRAN user plane (packet data convergence protocol/radio link control/media access control/physical) and control plane (radio resource control) protocol terminations towards wireless communication devices such as user equipment 420 and other devices such as machines 425 (e.g., an appliance, television, meter, etc.). The base stations 410 are interconnected with X2 interfaces or communication links (designated “X2”) and are connected to the wireless communication devices such as user equipment 420 and other devices such as machines 425 via Uu interfaces or communication links (designated “Uu”). The base stations 410 are also connected by S1 interfaces or communication links (designated “S1”) to an evolved packet core (“EPC”) including a mobile management entity/system architecture evolution gateway (“MME/SAE GW,” one of which is designated 430). The S1 interface supports a multiple entity relationship between the mobile management entity/system architecture evolution gateway 430 and the base stations 410. For applications supporting inter-public land mobile handover, inter-eNB active mode mobility is supported by the mobile management entity/system architecture evolution gateway 430 relocation via the S1 interface.

The base stations 410 may host functions such as radio resource management. For instance, the base stations 410 may perform functions such as Internet protocol (“IP”) header compression and encryption of user data streams, ciphering of user data streams, radio bearer control, radio admission control, connection mobility control, dynamic allocation of communication resources to user equipment in both the uplink and the downlink, selection of a mobility management entity at the user equipment attachment, routing of user plane data towards the user plane entity, scheduling and transmission of paging messages (originated from the mobility management entity), scheduling and transmission of broadcast information (originated from the mobility management entity or operations and maintenance), and measurement and reporting configuration for mobility and scheduling. The mobile management entity/system architecture evolution gateway 430 may host functions such as distribution of paging messages to the base stations 410, security control, termination of user plane packets for paging reasons, switching of user plane for support of the user equipment mobility, idle state mobility control, and system architecture evolution bearer control. The user equipment 420 and machines 425 receive an allocation of a group of information blocks from the base stations 410.

Additionally, the ones of the base stations 410 are coupled a home base station 440 (a device), which is coupled to devices such as user equipment 450 and/or machines (not shown) for a secondary communication system. The base station 410 can allocate secondary communication system resources directly to the user equipment 450 and machines, or to the home base station 440 for communications (e.g., local or D2D communications) within the secondary communication system. The secondary communication resources can overlap with communication resources employed by the base station 410 to communicate with the user equipment 420 within its serving area. For a better understanding of home base stations (designated “HeNB”), see 3 GPP TS 32.781 v.9.1.0 (2010-03), which is incorporated herein by reference. While the user equipment 420 and machines 425 are part of a primary communication system, the user equipment 420, machines 425 and home base station 440 (communicating with other user equipment 450 and machines (not shown)) may be a part of a secondary communication system to participate in, without limitation, D2D and machine-to-machine communications or other communications. Additionally, the user equipment 420 and machines 425 may form communication nodes along with other devices in the communication system.

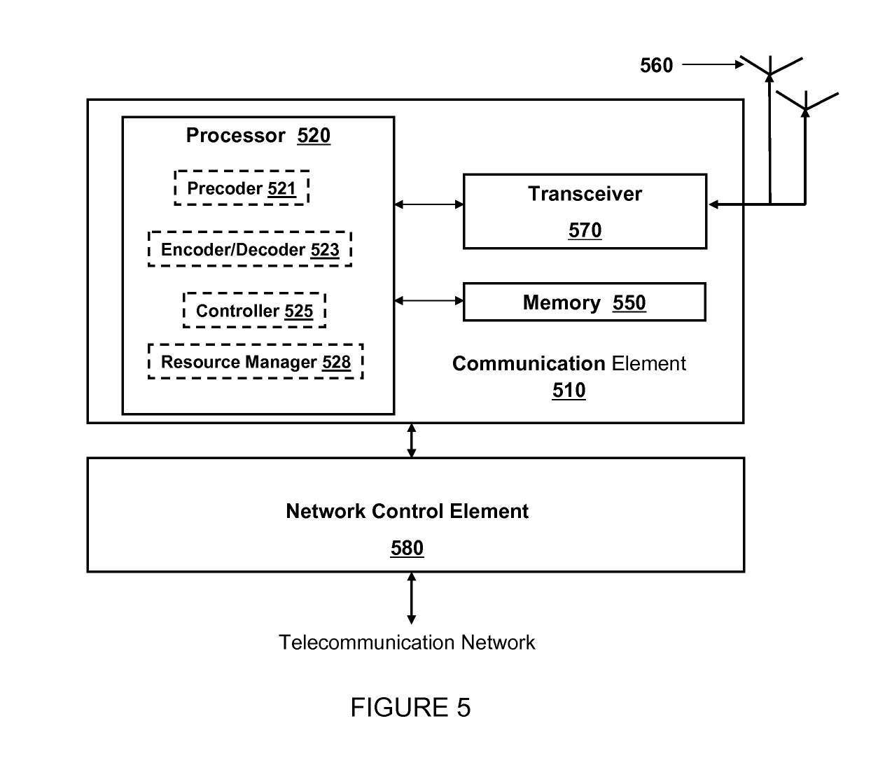

Turning now to FIG. 5, illustrated is a system level diagram of an embodiment of a communication element 510 of a communication system for application of the principles of the present invention. The communication element or device 510 may represent, without limitation, a base station, a wireless communication device (e.g., a subscriber station, terminal, mobile station, user equipment, machine), a network control element, a communication node, or the like. Additionally, the communication element or device 510 may form a communication node along with other devices in the communication system. When the communication element or device 510 represents a communication node such as a user equipment, the user equipment may be configured to communicate with another communication node such as another user equipment employing one or more base stations as intermediaries in the communication path (referred to as cellular communications). The user equipment may also be configured to communicate directly with another user equipment without direct intervention of the base station in the communication path. The communication element 510 includes, at least, a processor 520, memory 550 that stores programs and data of a temporary or more permanent nature, an antenna 560, and a radio frequency transceiver 570 coupled to the antenna 560 and the processor 520 for bidirectional wireless communications. The communication element 510 may be formed with a plurality of antennas to enable a multiple-input multiple output (“MIMO”) mode of operation. The communication element 510 may provide point-to-point and/or point-to-multipoint communication services.

The communication element 510, such as a base station in a cellular communication system or network, may be coupled to a communication network element, such as a network control element 580 of a public switched telecommunication network (“PSTN”). The network control element 580 may, in turn, be formed with a processor, memory, and other electronic elements (not shown). The network control element 580 generally provides access to a telecommunication network such as a PSTN. Access may be provided using fiber optic, coaxial, twisted pair, microwave communications, or similar link coupled to an appropriate link-terminating element. A communication element 510 formed as a wireless communication device is generally a self-contained device intended to be carried by an end user.

The processor 520 in the communication element 510, which may be implemented with one or a plurality of processing devices, performs functions associated with its operation including, without limitation, precoding of antenna gain/phase parameters (precoder 521), encoding and decoding (encoder/decoder 523) of individual bits forming a communication message, formatting of information, and overall control (controller 525) of the communication element, including processes related to management of communication resources (resource manager 528). Exemplary functions related to management of communication resources include, without limitation, hardware installation, traffic management, performance data analysis, tracking of end users and equipment, configuration management, end user administration, management of wireless communication devices, management of tariffs, subscriptions, security, billing and the like. For instance, in accordance with the memory 550, the resource manager 528 is configured to allocate primary and second communication resources (e.g., time and frequency communication resources) for transmission of voice communications and data to/from the communication element 510 and to format messages including the communication resources therefor in a primary and secondary communication system. Additionally, the resource manager 528 may manage interference between communication nodes in the primary and secondary communication system.

The execution of all or portions of particular functions or processes related to management of communication resources may be performed in equipment separate from and/or coupled to the communication element 510, with the results of such functions or processes communicated for execution to the communication element 510. The processor 520 of the communication element 510 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The transceiver 570 of the communication element 510 modulates information on to a carrier waveform for transmission by the communication element 510 via the antenna(s) 560 to another communication element. The transceiver 570 demodulates information received via the antenna(s) 560 for further processing by other communication elements. The transceiver 570 is capable of supporting duplex operation for the communication element 510.

The memory 550 of the communication element 510, as introduced above, may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 550 may include program instructions or computer program code that, when executed by an associated processor, enable the communication element 510 to perform tasks as described herein. Of course, the memory 550 may form a data buffer for data transmitted to and from the communication element 510. Exemplary embodiments of the system, subsystems, and modules as described herein may be implemented, at least in part, by computer software executable by processors of, for instance, the wireless communication device and the base station, or by hardware, or by combinations thereof. As will become more apparent, systems, subsystems and modules may be embodied in the communication element 510 as illustrated and described herein.

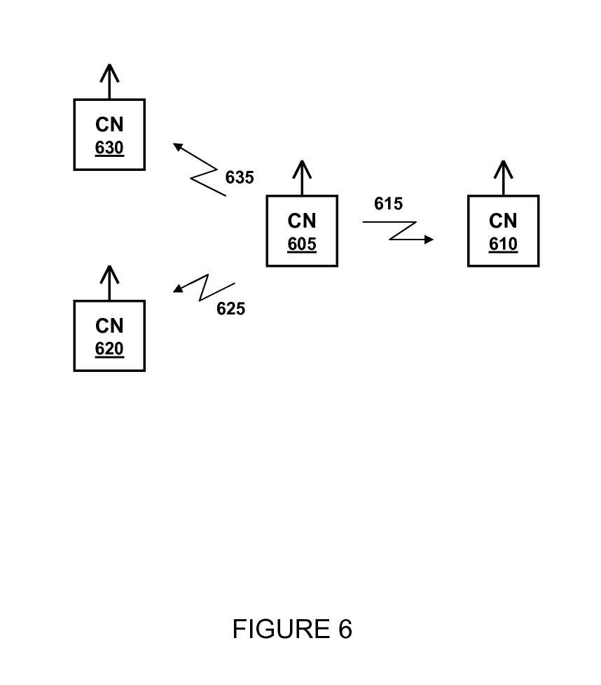

Turning now to FIG. 6, illustrated is a system level diagram of an embodiment of a communication system including communication nodes (“CN”) that provides an environment for the application of the principles of the present invention. A first communication node 605 has data to transmit to a second communication node 610 via a communication link 615. On a given communication or radio resource, the first communication node 605 achieves more throughput by using a higher transmitter power level. A higher transmitter power level, however, may increase unwanted interference via communication links 625, 635 to third and fourth communication nodes 620, 630, respectively.

As introduced herein, interference-aware scheduling communication nodes select a transmitter power level to augment (e.g., maximize) a utility function that takes both the communication node's own throughput gain and losses at another communication node (referred to as an interfered communication node such as a nearby communication node) into account, including consideration of communication circumstances at the nearby communication node. The transmitter power level may be chosen in combination with choosing other communication resources. For example, depending on circumstances, the first communication node 605 might decide not to transmit at all because losses at the nearby communication node may outweigh its own gain. The first communication node 605 might transmit at the highest possible transmitter power level if the gain in throughput outweighs losses at the nearby communication node. The first communication node 605 might transmit at a mid-range transmitter power level to strike a balance between its own gain and losses at the nearby communication node.

In general, a utility function in interference-aware scheduling may include the sum of throughputs at each communication node. Another example for a utility function is the sum of a logarithm of the throughput at each communication node. Throughput may be determined as the number of bits successfully transmitted in a given time (e.g., in bits per second). Since the transmission of bits may involve interleaving, coding, retransmissions or other techniques that require some duration of time, it may be preferable to use an estimate of throughput instead. Throughput may be estimated based on a signal-to-noise plus interference ratio (“SNIR”) and a bandwidth (“BW”). For example, an estimated throughput TPₑₛₜ of a communication or radio resource with a bandwidth may be estimated as a channel capacity TPₑₛₜ=BW log₂(1+SNIR), and estimation may be performed by looking up the estimated throughput TPₑₛₜ for a given value of SNIR from a table. A communication node may determine a communication resource throughput that is achieved on a given communication resource, for example, a communication channel or sub-band. A communication node may determine a total throughput that is achieved on all communication or radio resources in use by the communication node.

The communication or radio environment experienced by nearby communication nodes can differ substantially. For example, one communication node may be in a more crowded or sparsely populated location than its nearby communication nodes. A line-of-sight interferer may block part of the communication band locally, especially an industrial, scientific and medical (“ISM”) radio band (e.g., a band used by a wireless local area network (“WLAN”)). A communication node may serve a different number of users than a nearby communication node.

As introduced herein, the interference-aware scheduling utility function takes into account that a same throughput may be much more valuable to a “resource-poor” communication node than to a “resource-rich” communication node, and thereby takes into account environmental circumstances of both communication nodes. Improving “fairness” in distribution of communication resources (including a transmitter power level associated with the resource), which is harder to achieve than simply maximizing a summed throughput, requires that a communication node be aware of environmental circumstances at a nearby communication node. For example, a throughput gain or loss of ten kilobits per second (“kbps”) is less important to a communication node that is currently able to transmit 1000 kbps to a single user than to another communication node achieving only 100 kbps that are shared among three communication links.

An improved interference-aware scheduling solution can be configured to use a reasonable amount of signaling. The communication nodes operating in nearby communication networks may be unsynchronized and thus may require temporary resynchronization to receive environmental reports. The interference-aware scheduling signaling is preferably tied to the communication resource (e.g., a subband, a time or a frequency slot) in question. A “bulk” report that bundles data from many subbands may be lost due to independent interference on a reporting subband.

It is further desirable for interference-aware scheduling signaling not to rely on the identities of reporting communication nodes. For example, a typical media access control (“MAC”) address uses 48 bits. The actual payload data of a one communication resource report can be much smaller. When orthogonal communication resources are used to enable the reception of multiple simultaneous interference-aware scheduling signaling reports, the cost for transmitting one bit increases accordingly.

Thus, in the interference-aware scheduling process introduced herein, communication nodes broadcast information about interference status on a communication resource such as an uplink shared channel. A weighting factor is reported by potentially interfered communication nodes that indicates the “importance” of a communication resource. For instance, the communication resource may be more important relative to another communication resource, if it has a high signal-to-noise plus interference ratio, or conveys more information. A communication resource may be more important to a communication node than to another communication node, if the communication node has less communication or radio resources available to choose from, is deployed in a more crowded communication environment or suffers from a higher level of interference, for example. A communication resource may be more important if it is used for traffic with a higher priority, for example, voice over Internet protocol or streaming video traffic that has stringent requirements on latency. A transmitting communication node predicts interference it causes to nearby communication nodes by transmitting on the same communication resource. The transmitting communication node chooses a transmitter power level for a “fair” compromise between its own communication gain and others' losses, which is a cooperative arrangement. A “fair” compromise depends on environmental circumstances of the involved communication nodes. A utility function may be employed wherein throughput gained by a transmitting communication node and throughput lost by interfered communication nodes are not equally weighted.

A flexible spectrum usage (“FSU”) priority scheme is an example of an interference management scheme. Another interference management scheme is referred to as resource trading as described in IEEE Standard 802.16h, entitled “Part 16: Air Interface for Fixed Broadband Wireless Access Systems—Improved Coexistence Mechanisms for License-Exempt Operation,” dated Jul. 30, 2010. A further interference management scheme is decentralized communication resource coordination to improve fairness as described in a publication entitled “Cognitive Wireless Communication Networks,” by Ekram Hossain, et al., ISBN 978-0-387-68830-5, Springer 2007, and in a publication entitled “Distributed Spectrum Allocation via Local Bargaining,” by Cao, et al., IEEE SECON 2005 proceedings. Interference-aware scheduling, in general, implements distributed communication resource allocation schemes, for example, as described in a publication entitled “Distributed Resource Allocation Schemes,” by David A. Schmidt, et al., IEEE Signal Processing Magazine, vol. 26, issue 5, September 2009 Additionally, an application related to the interference reporting is disclosed in PCT Application No. PCT/CN2010/076867, entitled Method and Apparatus for Interference-Aware Wireless Communications,” by Nentwig, et al., filed Sep. 14, 2010. The aforementioned references are incorporated herein by reference.

As introduced herein, an interference-aware scheduling process at a communication node that is prepared to transmit (also referred to as a “transmitting communication node”) employs general interference-aware scheduling that includes a weighting factor that accounts for an environmental communication circumstance at another (e.g., nearby or neighboring) communication node (also referred to as an “interfered communication node”). The transmitting communication node, such as the first communication node 605 illustrated in FIG. 6, receives an interference message including reported interference characteristics such as a reported received signal strength and a reported noise-and-interference level, and a reported weighting factor at an interfered communication node such as the third communication node 620. The transmitting communication node may determine a transmitter power level “P” to augment (e.g., maximize) a utility function u(P) depending on these factors and over a transmitter power level range. The interference message including the reported received signal strength, the reported noise-and-interference level, and the reported weighting factor may be transmitted by the interfered communication node or by a base station.

A utility function may relate the effect of transmitter power level “P” between several communication nodes. In one example, a fixed transmitter power level may be divided between a set of communication or radio resources to lessen (e.g., minimize) a reduction of throughput at several interfered communication nodes. The reduction of throughput at each interfered communication node may be weighted with a weighting factor received in an interference message from the interfered communication node. In another example, the utility function also includes the throughput achieved by the transmitting communication node. The utility function may relate throughput achieved by the transmitting communication node to a loss of throughput at an interfered communication node. The utility function may select the transmit power level to augment (e.g., maximize) the utility function, in other words, balance the loss of throughput at the interfered communication node with the throughput gained by the transmitting communication node. An example for a utility function in interference-aware scheduling is the sum of weighted throughputs at each communication node. Another example for a utility function is the sum of a logarithm of each weighted throughput at the communication nodes. Another example for a utility function is the sum of weighted logarithms of each throughput at the communication nodes.

The transmitting communication node may also include a weighting factor (a local weighting factor) that reflects its own communication circumstance in its determination of interference-aware scheduling. The transmitting communication node may multiply its own throughput with weighting factor and include it as a term in the utility function. The transmitting communication node may also compute a predicted received signal strength and a predicted noise-and-interference level in its determination of its own weighting factor in an interference-aware scheduling utility function. The process may be extended to multiple communication resources such as multiple time and frequency slots. The transmitting communication node may select a set of communication resources for transmission and determine a transmitter power level for each communication resource to augment (e.g., maximize) a utility function that depends on all of the communication resources in the set and over a transmitter power level range.

When a transmitter power level is changed from a previous transmitter power level, it can be expected that an interfered communication node's reported weighting factor will also change in the next reporting round due to the resulting change in interference. To mitigate this effect, large changes in transmitter power level can be limited. A change in a transmitter power level at a transmitting communication node can be limited depending on a weighting factor at an interfered communication node. The limitation optionally can be made over a time interval when the reported weighting factor exceeds a predetermined threshold. The limitation of the change in transmitter power level can be applied when at least one reported weighting factor out of a plurality of received reports exceeds the predetermined threshold.

Alternatively, the weighting factor can be recalculated depending on the considered transmitter power level. This is possible since information that was used by the interfered communication node to calculate its reported weighting factor is available at the transmitting communication node. A solution may include knowing its own contribution to interference reported by the interfered communication node (see, e.g., PCT Application No. PCT/CN2010/076867). The utility function depends on a calculated weighting factor at the interfered communication node, which can be determined by adjusting the reported weighting factor of the interfered communication node with the reported interference characteristics such as the reported received signal strength and the reported noise-and-interference level, and the transmitter power level at the transmitting communication node.

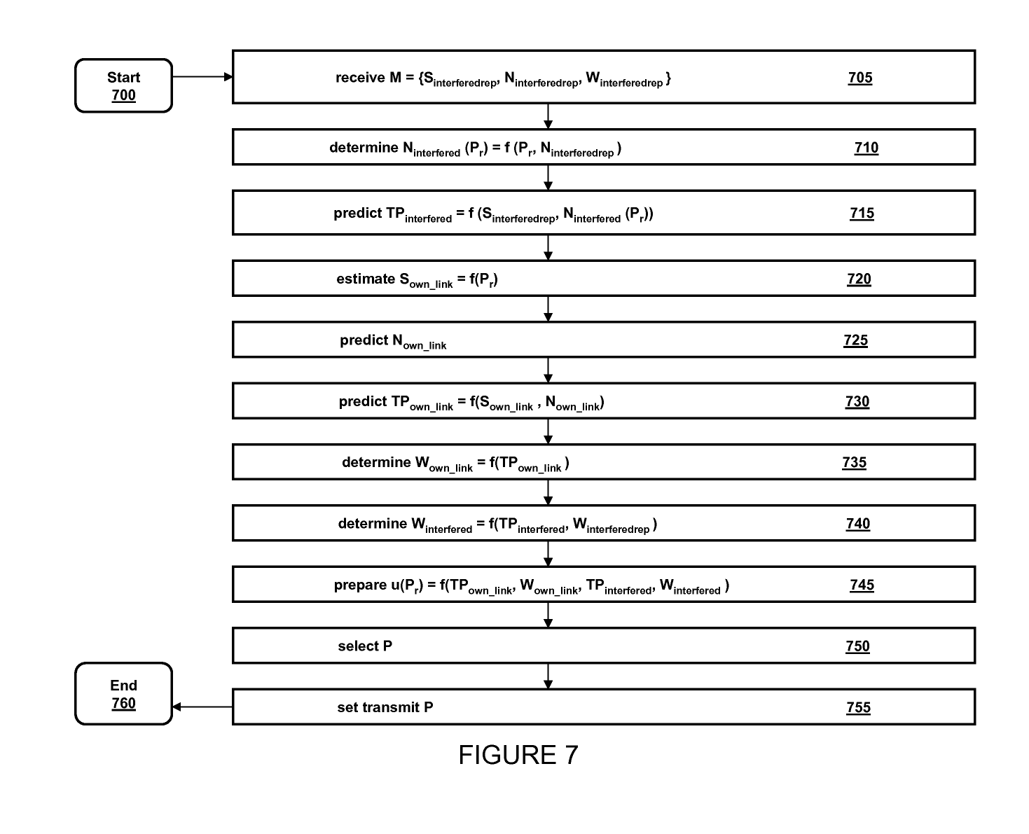

Turning now to FIG. 7, illustrated is a flowchart of an embodiment of a method of selecting a transmitter power level by a communication node (e.g., the first communication node 605 illustrated in FIG. 6) according to the principles of the present invention. The communication node that is prepared to transmit a message (also referred to as a “transmitting communication node”) selects a transmitter power level according to an interference-aware scheduling utility function that accounts for interference with another communication node (e.g., an “interfered communication node” such as a nearby or neighboring communication node) including characteristics of communication resources to an intended receiving communication node and to the interfered communication node for which communication may be affected.

The process starts a step or module 700. In a step or module 705, the communication node that is preparing to transmit a message receives an interference message “M” for a communication resource depending on the interfered communication node's reported interference characteristics such as a reported received signal strength S_{interferedrep} and a reported noise-and-interference level N_{interferedrep}, and a reported weighting factor W_{interferedrep}. The reported weighting factor W_{interferedrep} indicates an importance of the communication resource to the interfered communication node. As an example, the interference message may originate from the third communication node 620 illustrated in FIG. 6, or may be transmitted from a base station. In a step or module 710, the transmitting communication node determines a noise-and-interference level N_{interfered}(Pᵣ) at the interfered communication node as a function of the transmitting communication node transmitter power level range Pᵣ for the respective communication resource such as a time and frequency slot. The noise-and-interference level at the interfered communication node may be corrected for past transmission activity of the transmitting communication node 605 that contributed to the interference message describing the interfered communication node's communication interference characteristics. Additionally, the transmitting communication node may determine a received signal strength S_{interfered} at the interfered communication node for the respective communication resource. The received signal strength S_{interfered} may be determined as equal to the reported received signal strength S_{interferedrep} in the interference message.

In a step or module 715, a throughput TP_{interfered} for the interfered communication node is predicted by the transmitting communication node as a function of the transmitter power level range Pᵣ that affects the noise-and-interference level N_{interfered}(Pᵣ) at the interfered communication node, and the interfered communication node's reported received signal strength S_{interferedrep}. In one embodiment, the throughput TP_{interfered} is predicted as TP_{interfered}=BW log₂(1+S_{interfered}/N_{interfered}(Pᵣ)), where all variables are in linear units and BW is a bandwidth of a communication resource. The noise-and-interference level N_{interfered}(Pᵣ) at the interfered communication node may be predicted as N_{interfered}(Pᵣ)=N_{interferedrep} (Pᵣ−Pₚᵣₑᵥ)/L, where L is a path loss estimate, and Pₚᵣₑᵥ is a transmitter power level of the transmitting communication node at an earlier time interval, during which the interfered communication node determined the interference characteristics.

The prediction may be based on a predetermined throughput versus signal-to-noise plus interference (“SNIR”) function (e.g., the function log(1+SNIR), which may be limited to the SNIR range [−3 decibels (“dB”), 25 dB]). In a step or module 720, the transmitting communication node estimates a quality parameter such as a received signal strength S_{own}_{_{—}}ₗᵢₙₖ at the intended receiving communication node (e.g., the second communication node 610 illustrated in FIG. 6) using a path-loss estimate. A path loss estimate L may be obtained by relating a detected power level P_{det} of a known signal feature, such as a pilot tone, reference symbol, preamble, synchronization signal or the like to a known transmitter power level P_{src} of the feature. The transmitter power level may be predetermined or encoded into a message such as a broadcast message, for example. The path loss estimate may be calculated as L=P_{src}/P_{det}, in linear units.

In a step or module 725, the transmitting communication node predicts a quality parameter such as a noise-and-interference level N_{own}_{_{—}}ₗᵢₙₖ at the intended receiving communication node (e.g., based on a received noise-and-interference level report such as a channel quality indicator (“CQI”)). In a step or module 730, the transmitting communication node predicts a throughput TP_{own}_{_{—}}ₗᵢₙₖ to the intended receiving communication node as a function of the transmitter power level range Pᵣ, using the signal strength and noise-and-interference level predictions. In a step or module 735, the transmitting communication node determines a weighting factor W_{own}_{_{—}}ₗᵢₙₖ for the communication link to the intended receiving communication node as a function of its own throughput, which depends on the transmitter power level range. The weighting factor W_{own}_{_{—}}ₗᵢₙₖ indicates the relative importance to the transmitting communication node of its own throughput achieved with the communication resource. The weighting factor in general may be limited to the range from zero to one.

In a step or module 740, the transmitting communication node determines a weighting factor W_{interfered} for the interfered communication node, indicating the relative importance of throughput by the interfered communication node on the communication resource. The weighting factor W_{interfered} of the interfered communication node may depend on its throughput TP_{interfered}, the reported weighting factor W_{interferedrep} and the transmitter power level range. In one embodiment, the interfered weighting factor W_{interfered} equals the reported weighting factor W_{interferedrep}.

In a step or module 745, the transmitting communication node prepares a utility function u(P) that depends on the predicted throughput TP_{own}_{_{—}}ₗᵢₙₖ of the communication link to the intended receiving communication node, the predicted throughput TP_{interfered} of the interfered communication link to the interfered communication node, the weighting factor W_{own}_{_{—}}ₗᵢₙₖ of the communication link to the intended receiving communication node, and the weighting factor W_{interfered} of the interfered communication link to the interfered communication node, all of which are a function of the transmitter power level range Pᵣ of the transmitting communication node. In other words, the transmitting communication node applies the weighting factor W_{own}_{_{—}}ₗᵢₙₖ of the communication link to the intended receiving communication node to the predicted throughput TP_{own}_{_{—}}ₗᵢₙₖ and the weighting factor W_{interfered} of the interfered communication link to the interfered communication node to the predicted throughput TP_{interfered}.

If other communication nodes experience interference, then an interference message is received from each interfered communication node, and an individual weighting factor is determined for each interfered communication node. An example for a utility function is:

U(Pᵣ)=TP_{own}_{_{—}}ₗᵢₙₖ(Pᵣ)W_{own}_{_{—}}ₗᵢₙₖ+sum_{j=(all interfered nodes)}(TP_{interfered,j}W_{interfered,j}),

wherein the sum is iterated using index j over all interfered communication nodes. Another example for a utility function is:

U(Pᵣ)=log(TP_{own}_{_{—}}ₗᵢₙₖ(Pᵣ)W_{own}_{_{—}}ₗᵢₙₖ)+sum_{j=(all interfered nodes)}{log(TP_{interfered,j}W_{interfered,j})}.

In a step or module 750, the transmitting communication node selects a transmitter power level P to augment (e.g., maximize) the utility function u(P). In one embodiment, an exhaustive search is performed to maximize the utility function u(P) over the transmitter power level range (e.g., in 0.5 dB steps of transmitter power level). In an alternative embodiment, the utility function u(P) is maximized using an analytic technique. In a step or module 755, the transmitting communication node uses the selected transmitter power level P to transmit a message on the respective communication resource to the intended receiving communication node and the method ends in step or module 760.

At a nearby communication node which may be subject to interference (again, an interfered communication node), the weighting factor may be determined for a communication resource in agreement with a constraint function. The interfered communication node determines for the communication resource interference characteristics such as a signal strength and a noise-and-interference level, and transmits, in an interference message, a weighting factor, a signal strength, and a signal-to-noise plus interference ratio. The weighting factor may be based on a ratio of a throughput measure on a communication resource to a summed throughput measure on a set of communication resources.

The constraint function for the weighting factor may depend on a number of connected communication nodes. The constraint function may constrain weighting factors on multiple communication resources. For example, the constraint function may sum all reported weights on all communication resources, and may be limited to all weights with a magnitude less than a threshold level, such as a threshold level of one. The constraint function may be dependent on a number of connected communication nodes, and may be employed to constrain a plurality of respective weighting factors for a plurality of communication resources. An example for a constraint function is sum_{j=all used radio resources}(Wⱼ)<=1, where Wⱼ is the weighting factor of communication or radio resource j and index j iterates over all communication or radio resources. A constraint function may be required by a radio standard, for example, to ensure fair reporting by all communication nodes.

In interference-aware scheduling, the intent is that the utility function balances gains and losses with fairness among communication nodes. As introduced herein, weighting factors “fairly” reflect the importance of throughput associated with a communication resource to a communication node, which may differ because the environmental circumstances of each communication node may be different. Again, the importance may reflect a bandwidth availability associated with the communication node. Based on the utility function, a transmitter power level is chosen.

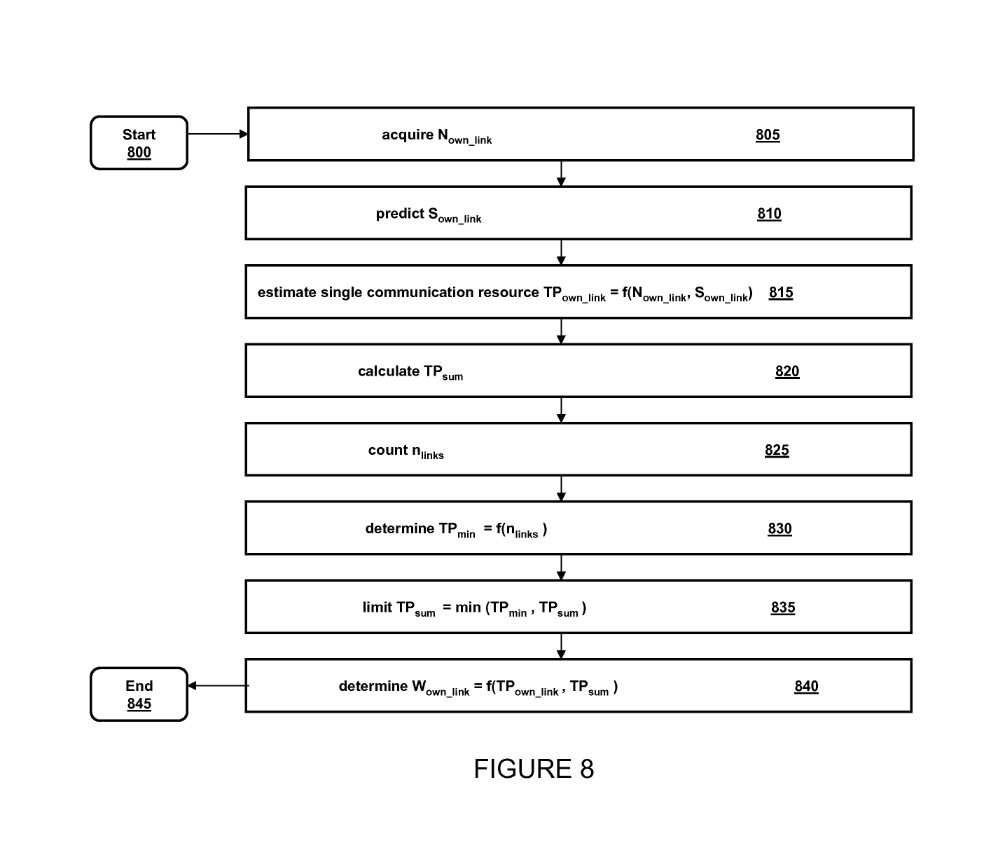

If an interfered communication node has acquired only a small number of communication resources, the “importance” of the communication resources can depend strongly on the transmitter power level employed by the transmitting communication node. For example, a weighting factor function (as described hereinbelow with reference to FIG. 8) may be designed to ensure (e.g., guarantee) each communication link a minimum throughput. If so, the importance (indicated by the weighting factor) of a communication resource will increase strongly with additional interference once that communication node's throughput falls below a limit. For example, a communication node that does not achieve a predetermined minimum throughput may be allowed to select a communication or radio resource and transmit a predetermined maximum valid weighting factor.

This can be taken into account by predicting (at the transmitting communication node) how the weighting factor at the interfered communication node will change with the transmitter power level at the transmitting communication node. For example, using a suitable weighting factor and knowing its own contribution to the reported interference, the transmitting communication node can back-trace the reported interference calculation, and thereby predict the next round's reported weighting factor for any choice of transmitter power level.

Alternatively, a change in a weighting factor at an interfered communication node can be disregarded. If so, the maximum increase in transmitter power level on a communication resource can be limited, wherein the interference to the interfered communication node is known to happen. This limits overshooting a change in transmitter power level. For example, the transmitting communication node may increase its transmitter power level to reduce a level of interference to a communication node that is intended to receive its message. As a result, the interference such as reported by another communication node (e.g., an interfered communication node) increases in the next round of calculation. The transmitting communication node is then forced to reduce its transmitter power level, illustrating the possibility of instability in the process of calculating a transmitter power level.

The question of stability in setting a transmitter power level relates to robustness of interference-aware scheduling and related communication processes in a highly loaded communication system. The question of stability can be addressed by a system designer once a communication system simulator is available. The embodiments presented herein predict the weighting factor of the interfered communication node resulting as a function of a transmitter power level range at the transmitting communication node in the augmentation (e.g., optimization) of a utility function. In an exemplary embodiment, the dependency of the weighting factor at the interfered communication node on the transmitter power level range (see, e.g., step or module 740) may be omitted, and this dependency may be set as a constant.

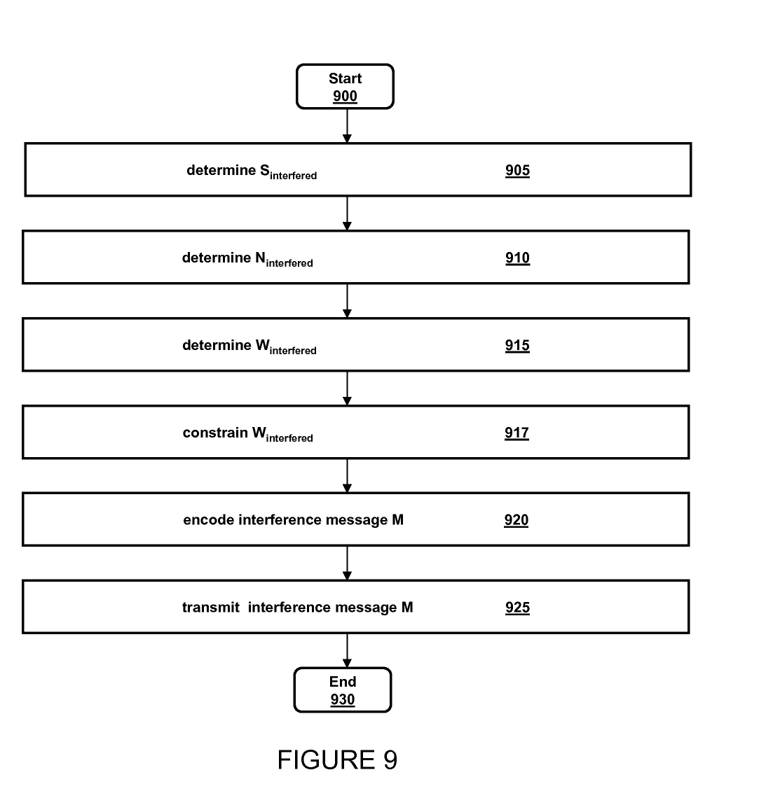

Turning now to FIG. 8, illustrated is a flowchart of an embodiment of a method of determining a weighting factor by a communication node in accordance with the principles of the present invention. From the perspective of the transmitting communication node, the method of determining the weighting factor may be implemented in accordance with respect to step or module 735 illustrated and described with respect to FIG. 7. The method of determining the weighting factor may be repeated over a transmitter power level range. From the perspective of the interfered communication node, the method of determining the weighting factor may be implemented in accordance with respect to step or module 915 illustrated and described with respect to FIG. 9. For the purpose of clarity and in the spirit of an exemplary embodiment, the method that follows will be described from the perspective of a transmitting communication node to a receiving communication node. Those skilled in the art, however, should understand that the same principles may be applied to other communication nodes in a communication system.

The process starts at step or module 800. In a step or module 805, a quality parameter such as a noise-and-interference level N_{own}_{_{—}}ₗᵢₙₖ at a receiving communication node such as the second communication node 610 illustrated in FIG. 6 is acquired. The acquisition may use a noise-and-interference level report transmitted by the receiving communication node from an earlier round. Alternatively, the acquisition may subtract a path loss estimate (in dB) to the receiving communication node from a noise-and-interference level measurement (in dB) made at, for instance, the transmitting communication node such as the first communication node 605 illustrated in FIG. 6. In a step or module 810, another quality parameter such as a received signal strength S_{own}_{_{—}}ₗᵢₙₖ at the receiving communication node such as the second communication node 610 illustrated in FIG. 6 is predicted. The prediction may use a received signal strength from an earlier round. The prediction may be based on the predicted noise-and-interference level and a constant, for example, a predicted noise-and-interference level +10 dB. If the method is implemented with respect to step or module 735 illustrated in FIG. 7, the received signal strength may be estimated by subtracting a path loss estimate (in dB) to the intended receiving communication node resulting from the transmitter power level.

In a step or module block 815, the throughput TP_{own}_{_{—}}ₗᵢₙₖ of a single/negotiated communication resource is predicted. For example, the prediction may employ a function log (1+SNIR), wherein SNIR is the predicted signal-to-noise plus interference ratio. In an alternative embodiment, a mapping function such as a modulation and coding scheme (“MCS”) table dependent on a predicted signal-to-noise ratio may be employed. In one example embodiment, the throughput is estimated as TP_{own}_{_{—}}ₗᵢₙₖ=BW log₂(1+SNIR/c), where BW is the bandwidth of the communication or radio resource, and c is a predetermined constant (e.g., c=1.8). In a step or module 820, a summed throughput TPₛᵤₘ of all communication resources used for transmission is calculated. A function such as that employed in step or module 815 may be employed to predict SNIR. In a step or module 825, the number of communication links nₗᵢₙₖₛ supported by the transmitting communication node is counted. In FIG. 6, while only a single communication link 615 is illustrated between the transmitting communication node (the first communication node 605) and the intended receiving communication node (the second communication node 610), other communication nodes might be served if transmitting communication node is an access point.

In a step or module block 830, a minimum throughput value TPₘᵢₙ for the summed throughput is determined. The minimum throughput value may be a predetermined constant, for example, 100 kilobits-per-second (“kbps”) for every maintained communication link. In a step or module 835, the calculated summed throughput is limited to not fall below the minimum throughput value TPₘᵢₙ computed in the step or module 830. In a step or module 840, the weighting factor W_{own}_{_{—}}ₗᵢₙₖ is determined as a ratio of predicted resource throughput computed in the step or module 815 to the summed throughput computed in the step or module 835 (e.g., W_{own}_{_{—}}ₗᵢₙₖ=TP_{own}_{_{—}}ₗᵢₙₖ/TPₛᵤₘ). The method ends in a step or module 845.

Turning now to FIG. 9, illustrated is a flowchart of an embodiment of generating an interference message M by a communication node (e.g., an interfered communication node such as the third communication node illustrated in FIG. 6) in accordance with the principles of the present invention. The interference message may be received by a communication node preparing to transmit data (e.g., a transmitting communication node such as the first communication node 605 illustrated in FIG. 6). The transmitting communication node receives the interference message from the interfered communication node including a weighting factor W_{interfered}, and interference characteristics such as a signal strength S_{interfered}, and a noise-and-interference level N_{interfered}. For the purpose of clarity and in the spirit of an exemplary embodiment, the method that follows will be described from the perspective of an interfered communication node. Those skilled in the art, however, should understand that the same principles may be applied to other communication nodes in a communication system.

The method begins in a step or module 900. In a step or module 905, an interference characteristic such as a received signal strength S_{interfered} on a communication or radio resource is determined at the interfered communication node. In a step or module 910, another interference characteristic such as a noise-and-interference level N_{interfered} on the communication resource is determined by the interfered communication node. Alternatively, the determination of the interference characteristics may subtract a path loss estimate (in dB) between the interfered communication node and the transmitting communication node.

In a step or module 915, a weighting factor W_{interfered} is determined. The weighting factor may be determined based on signal strength, summed throughput, and relative importance of the communication resource. In a step or module 917, the weighting factor is constrained with a constraint function. A constraint function may be constructed as described hereinabove with reference to FIG. 6. In a step or module 920, a signal strength, noise-and-interference level, and weighting factor are formatted and encoded into the interference message. Encoding the weighting factor may include quantization, which may be performed, without limitation, on a logarithmic scale (e.g., a logarithmic scale using three bits). In a step or module 925, the interference message is transmitted to a transmitting communication node and the method ends in a step or module 930.

In another embodiment, only limited changes in a transmitter power level are allowed for a communication resource when an interfered communication node has been detected by a communication node that prepares to transmit a message. Limiting changes to a transmitter power level prevents “overshooting” a change in the transmitter power level when a large change would result in an excessive change in a weighting factor. Limiting the rate of increase in a transmitter power level in the presence of an interfered communication node also improves system robustness when more than one communication node receives an interference message and decides to increase a transmitter power level.

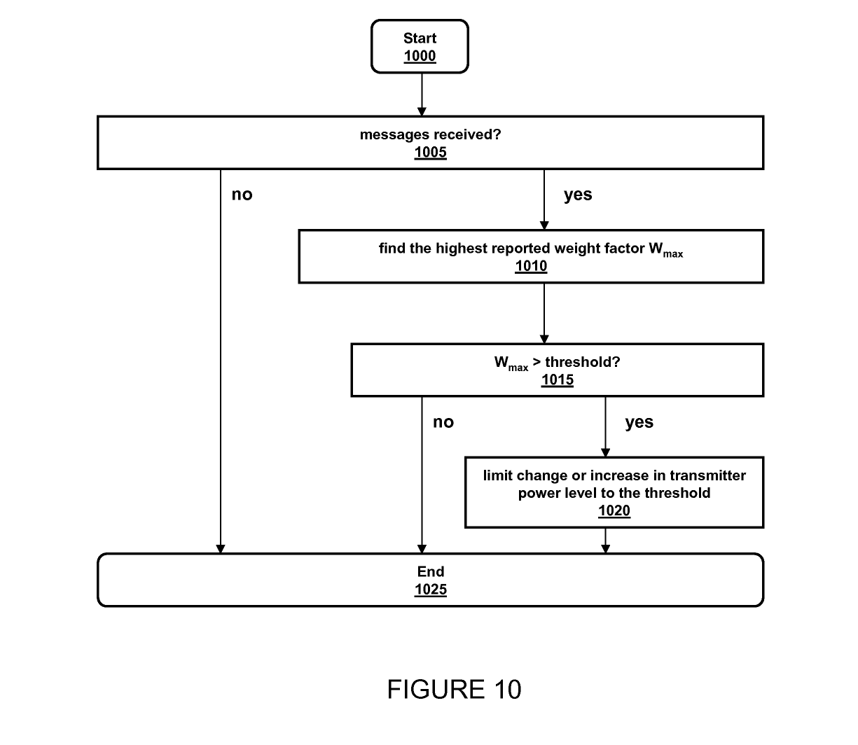

Turning now to FIG. 10, illustrated is a flowchart of an embodiment of a method of selecting a transmitter power level for a message by a communication node (e.g., a transmitting communication node such as the first communication node 605 illustrated in FIG. 6) that may interfere with another communication node (e.g., an interfered communication node such as the third communication node 620 illustrated in FIG. 6) in accordance with the principles of the present invention. The method starts in a step or module 1000. In a step or module 1005, the transmitting communication node determines whether interference messages have been received from interfered communication nodes. If no interference message has been received, the method ends in a step or module 1025.

If at least one interference message has been received, the transmitting communication node finds the highest reported weighting factor Wₘₐₓ of all the received reports in a step or module 1010. In a step or module 1015, the transmitting communication node compares the highest reported weight factor Wₘₐₓ against a threshold. If the highest reported weighting factor Wₘₐₓ is not above a threshold, the method ends in the step or module 1025. If the highest reported weighting factor Wₘₐₓ is above the threshold, the transmitting communication node limits the increase in transmitter power level for a message over a previous processing round to the threshold, and the method ends in the step or module 1025. The change in transmitter power level may be restricted to an increase in transmitter power level. The maximum change in transmitter power level (i.e., the threshold) may be a predetermined constant. The maximum change in transmitter power level at the transmitting communication node may depend on the highest reported weighting factor Wₘₐₓ, for example, the maximum change may be limited to the value 10·(1−Wₘₐₓ) dB, with Wₘₐₓ a value falling in the range [0, 1]. In an alternative embodiment, if the highest reported weighting factor Wₘₐₓ is above the threshold, the transmitting communication node limits a change in transmitter power level compared to a previous processing round to the threshold in a step or module 1020, and the method ends in a step or module 1025.

Better fairness and system efficiency can thus be obtained with the introduced improvements to interference-aware scheduling. This can be accomplished with reasonable additional signaling overhead over conventional interference-aware scheduling. If the reported weighting factors, etc., are reported using a sufficient number of bits to provide a low level of quantization error, a communication node preparing to transmit can come close to an optimum solution using a single reporting cycle. In such circumstances there would generally be no need to repeatedly report interference data and iterate. The process does not require a distinction between communication nodes such as user equipment and an access point/base station node. It can be implemented in communication nodes that support devices that communicate through an access point/base station as well as D2D communication links.

Thus, an apparatus, method and system are introduced herein to control a transmitter power level to manage interference between communication nodes in a communication system. In one embodiment, an apparatus (e.g., embodied in a communication node such as a user equipment) includes a processor and memory including computer program code. The memory and the computer program code are configured to, with the processor, cause the apparatus to receive an interference message including a reported interference characteristic (e.g., at least one of a reported signal strength and a reported noise-and-interference level) associated with a communication resource employed by an interfered communication node and a reported weighting factor indicating an importance of the communication resource to the interfered communication node. The memory and the computer program code are also configured to, with the processor, cause the apparatus to generate a message for a receiving communication node employing the communication resource, and select a transmitter power level for the message as a function of the reported interference characteristic and the reported weighting factor. The transmitter power level may be a function of a transmitter power level range including a finite set of power levels, may be limited from a previous transmitter power level.

In a related embodiment, the memory and the computer program code are further configured to, with the processor, cause the apparatus to predict a throughput over the communication resource to the interfered communication node as a function of a transmitter power level range, determine a weighting factor as a function of the reported weighting factor, apply the weighting factor to the throughput to obtain a weighted throughput, and select the transmitter power level by applying the transmitter power level range to a utility function including the weighted throughput. In some cases, the weighting factor may equal the reported weighting factor.

In another related embodiment, the memory and the computer program code are further configured to, with the processor, cause the apparatus to determine a quality parameter of the communication resource to the receiving communication node, predict a throughput over the communication resource to the receiving communication node as a function of the quality parameter and a transmitter power level range, determine a weighting factor as a function of the throughput, apply the weighting factor to the throughput to obtain a weighted throughput, and select the transmitter power level by applying the transmitter power level range to a utility function including the weighted throughput. In an alternative, but related embodiment, the memory and the computer program code are further configured to, with the processor, cause the apparatus to determine a quality parameter of the communication resource to the receiving communication node, predict a throughput over the communication resource to the receiving communication node as a function of the quality parameter and a transmitter power level range, predict a summed throughput over all communication resources employable by the apparatus, determine a weighting factor as a function of the throughput and the summed throughput, apply the weighting factor to the throughput to obtain a weighted throughput, and select the transmitter power level by applying the transmitter power level range to a utility function including the weighted throughput.

In another aspect, an apparatus (e.g., embodied in a communication node such as a user equipment) includes a processor and memory including computer program code. The memory and the computer program code are configured to, with the processor, cause the apparatus to determine an interference characteristic (e.g., at least one of a signal strength and a noise-and-interference level) associated with a communication resource employed by the apparatus, and determine a weighting factor indicating an importance of the communication resource to the apparatus. The memory and the computer program code are also configured to, with the processor, cause the apparatus to format the interference characteristic and the weighting factor into an interference message for transmission to a communication node. The memory and the computer program code are further configured to, with the processor, cause the apparatus to constrain the weighting factor in accordance with a constraint function, which may be dependent on a number of communication nodes connected to the apparatus. The memory and the computer program code are further configured to, with the processor, cause the apparatus to transmit the interference message over the communication resource to the communication node. The interference characteristic may be determined in accordance with a path loss to the communication node, and may be employable to ascertain a throughput over the communication resource. Although the apparatus, method and system described herein have been described with respect to cellular-based communication systems, the apparatus and method are equally applicable to other types of communication systems such as a WiMax communication system.

Program or code segments making up the various embodiments of the present invention may be stored in a computer readable medium or transmitted by a computer data signal embodied in a carrier wave, or a signal modulated by a carrier, over a transmission medium. For instance, a computer program product including a program code stored in a computer readable medium may form various embodiments of the present invention. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network communication channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1.-40. (canceled)

41. An apparatus, comprising:
a processor; and
memory including computer program code,
said memory and said computer program code configured to, with said processor, cause said apparatus to perform at least the following:
receive an interference message including a reported interference characteristic associated with a communication resource employed by an interfered communication node and a reported weighting factor indicating an importance of said communication resource to said interfered communication node;
generate a message for a receiving communication node employing said communication resource; and
select a transmitter power level for said message as a function of said reported interference characteristic and said reported weighting factor.

42. The apparatus as recited in claim 41, wherein said memory and said computer program code are further configured to, with said processor, cause said apparatus to predict a throughput over said communication resource to said interfered communication node and select said transmitter power level for said message as a function of said throughput.

43. The apparatus as recited in claim 41, wherein said memory and said computer program code are further configured to, with said processor, cause said apparatus to:
predict a throughput over said communication resource to said interfered communication node as a function of a transmitter power level range;
determine a weighting factor as a function of said reported weighting factor;
apply said weighting factor to said throughput to obtain a weighted throughput; and
select said transmitter power level by applying said transmitter power level range to a utility function including said weighted throughput.

44. The apparatus as recited in claim 43, wherein said weighting factor equals said reported weighting factor.

45. The apparatus as recited in claim 41, wherein said memory and said computer program code are further configured to, with said processor, cause said apparatus to determine a quality parameter of said communication resource to said receiving communication node and select said transmitter power level for said message as a function of said quality parameter.

46. The apparatus as recited in claim 41, wherein said memory and said computer program code are further configured to, with said processor, cause said apparatus to:
determine a quality parameter of said communication resource to said receiving communication node;
predict a throughput over said communication resource to said receiving communication node as a function of said quality parameter; and
select said transmitter power level for said message as a function of said throughput.

47. The apparatus as recited in claim 41, wherein said memory and said computer program code are further configured to, with said processor, cause said apparatus to:
determine a quality parameter of said communication resource to said receiving communication node;
predict a throughput over said communication resource to said receiving communication node as a function of said quality parameter and a transmitter power level range;
determine a weighting factor as a function of said throughput;
apply said weighting factor to said throughput to obtain a weighted throughput; and
select said transmitter power level by applying said transmitter power level range to a utility function including said weighted throughput.

48. The apparatus as recited in claim 41, wherein said memory and said computer program code are further configured to, with said processor, cause said apparatus to:
determine a quality parameter of said communication resource to said receiving communication node;
predict a throughput over said communication resource to said receiving communication node as a function of said quality parameter and a transmitter power level range;
predict a summed throughput over all communication resources employable by said apparatus;
determine a weighting factor as a function of said throughput and said summed throughput;
apply said weighting factor to said throughput to obtain a weighted throughput; and
select said transmitter power level by applying said transmitter power level range to a utility function including said weighted throughput.

49. The apparatus as recited in claim 41, wherein said reported interference characteristic comprises at least one of a reported signal strength and a reported noise-and-interference level for said communication resource employed by said interfered communication node.

50. The apparatus as recited in claim 41, wherein said transmitter power level is function of a transmitter power level range including a finite set of power levels.

51. The apparatus as recited in claim 41, wherein a change of said transmitter power level is limited from a previous transmitter power level.

52. A method, comprising:
receiving an interference message including a reported interference characteristic associated with a communication resource employed by an interfered communication node and a reported weighting factor indicating an importance of said communication resource to said interfered communication node;
generating a message for a receiving communication node employing said communication resource; and
selecting a transmitter power level for said message as a function of said reported interference characteristic and said reported weighting factor.

53. The method as recited in claim 52, further comprising predicting a throughput over said communication resource to said interfered communication node and selecting said transmitter power level for said message as a function of said throughput.

54. An apparatus, comprising:
a processor; and
memory including computer program code,
said memory and said computer program code configured to, with said processor, cause said apparatus to perform at least the following:
determine an interference characteristic associated with a communication resource employed by said apparatus;
determine a weighting factor indicating an importance of said communication resource to said apparatus; and
format said interference characteristic and said weighting factor into an interference message for transmission to a communication node.

55. The apparatus as recited in claim 54, wherein said memory and said computer program code are further configured to, with said processor, cause said apparatus to constrain said weighting factor in accordance with a constraint function.

56. The apparatus as recited in claim 55, wherein said constraint function is dependent on a number of communication nodes connected to said apparatus.

57. The apparatus as recited in claim 54, wherein said memory and said computer program code are further configured to, with said processor, cause said apparatus to determine said interference characteristic in accordance with a path loss to said communication node.

58. The apparatus as recited in claim 54, wherein said interference characteristic comprises at least one of a signal strength and a noise-and-interference level for said communication resource employed by said apparatus.

59. The apparatus as recited in claim 54, wherein said interference characteristic is employable to ascertain a throughput over said communication resource.

60. The apparatus as recited in claim 54, wherein said memory and said computer program code are further configured to, with said processor, cause said apparatus to transmit said interference message over said communication resource to said communication node.
